(19) United States
(12) Patent Application Publication
(10) Pub. No.: US 2026/0199879 A1
(43) Pub. Date: Jul. 16, 2026

(54) High-Sulfur Petroleum Coke-Based Sulfur Self-Doped Mesoporous Carbon-Supported Fe-TM Bimetallic Alloy Catalyst, Preparation Method, and Use Thereof

(71) Applicants: SHANDONG UNIVERSITY, Qingdao (CN); QINGDA LOW CARBON GREEN HYDROGEN INDUSTRIAL TECHNOLOGY RESEARCH INSTITUTE (QINGDAO) CO., LTD., Qingdao (CN); QINGDAO DANENG ENVIRONMENTAL PROTECTION EQUIPMENT CO., LTD., Qingdao (CN)

(72) Inventors: Jingcai CHANG, Qingdao (CN); Yulin HUANG, Qingdao (CN); Yong WANG, Qingdao (CN); Yang ZHANG, Qingdao (CN); Xin'an ZHANG, Qingdao (CN); Haoran WU, Qingdao (CN); Wei ZHANG, Qingdao (CN); Yong SHI, Qingdao (CN); Lianhai ZHANG, Qingdao (CN); Chen HUANG, Qingdao (CN)

(21) Appl. No.: 19/447,042

(22) Filed: Jan. 13, 2026

(30) Foreign Application Priority Data
Jan. 16, 2025 (CN) 2025100651903

(51) Int. Cl. B01J 23/755; B01J 23/745; B01J 27/02; B01J 35/61; B01J 35/64; B01J 37/00; B01J 37/06; B01J 37/08; B01J 37/18; C01B 3/0026

(52) U.S. Cl. CPC B01J 23/755; B01J 23/745; B01J 27/02; B01J 35/615; B01J 35/647; B01J 37/0036; B01J 37/06; B01J 37/088; B01J 37/18; C01B 3/0026

(57) ABSTRACT

A high-sulfur petroleum coke-based sulfur self-doped mesoporous carbon-supported Fe-TM bimetallic alloy catalyst, and a preparation method and use thereof are provided. The catalyst is an Fe-TM solid-solution alloy material supported on sulfur self-doped mesoporous carbon, formed by calcination under an inert atmosphere and reduction calcination under a hydrogen atmosphere after activation of high-sulfur petroleum coke by potassium ferrate. The catalyst can significantly reduce the peak dehydrogenation temperature of magnesium-based materials by 80 to 110 K. The catalytic effect is comparable to that of catalysts prepared by conventional routes, but the catalyst exhibits remarkable cost-effectiveness and environmental advantages, demonstrating the significant industrialization potential of high-sulfur petroleum coke in the field of hydrogen storage.

### CROSS-REFERENCE TO RELATED APPLICATIONS

The present application claims priority to Chinese Patent Application No. CN202510065190.3, filed on Jan. 16, 2025, and entitled “High-Sulfur Petroleum Coke-Based Sulfur Self-Doped Mesoporous Carbon-Supported Fe-TM Bimetallic Alloy Catalyst, Preparation Method, and Use Thereof,” the entire content of which is incorporated herein by reference for all purposes.

### TECHNICAL FIELD

The present disclosure relates to the technical field of solid waste valorization and hydrogen storage catalysis, and in particular to a high-sulfur petroleum coke-based sulfur self-doped mesoporous carbon-supported Fe-TM bimetallic alloy catalyst, and a preparation method and use thereof.

### BACKGROUND OF THE INVENTION

The information disclosed in this background section is only intended to increase an understanding of the general background of the present disclosure, and should not necessarily be regarded as an admission or any form of suggestion that such information constitutes prior art known to a person of ordinary skill in the art.

At present, hydrogen storage technologies can be mainly classified into three types: high-pressure gaseous storage, cryogenic liquid storage, and metal-hydride solid-state storage. Although the first two technologies perform well under specific conditions, they are limited by efficiency, cost, or safety issues and are difficult to meet future energy demands in different application scenarios. Metal-hydride hydrogen storage, especially magnesium-based solid-state hydrogen storage materials such as magnesium hydride (MgH₂), has attracted extensive attention in the field of solid-state hydrogen storage due to its relatively high hydrogen storage density (7.6 wt. %), abundant resources, low cost, etc. However, in practical applications, MgH₂ faces challenges such as a relatively high operating temperature, a large reaction enthalpy, and slow hydrogen absorption/desorption kinetics. Adding a catalytic component is an effective strategy for improving the hydrogen storage performance of MgH₂.

High-sulfur petroleum coke is an industrial byproduct generated during delayed coking in the petroleum industry. Its bulk sulfur content is greater than 3 wt %. As crude oil becomes increasingly high-sulfur and heavy, the total amount of high-sulfur petroleum coke produced by delayed coking has increased sharply. High-sulfur petroleum coke therefore faces comprehensive restrictions from factory discharge, customs clearance, to combustion use, and a serious oversupply, making high-value disposal or recycling/utilization as an urgent problem to be solved.

At present, there are disclosures in which high-sulfur petroleum coke is activated with strong bases or strong acids (e.g., KOH, NaOH, or H₃PO₄) to generate activated carbon. However, use of these activators can cause severe corrosion of equipment and requires a large amount of washing water. In addition, under strong chemical reaction conditions, the bulk sulfur in high-sulfur petroleum coke tends to become unstable and be released, and the sulfur resource potential contained therein is not fully utilized. Carbon materials loaded with metals can serve as catalysts to improve the hydrogen storage performance of magnesium-based materials. Meanwhile, doping nonmetal sulfur atoms into carbon materials can trigger a redistribution of atomic charge density and further improve catalytic ability. Therefore, developing a green and economical functionalization strategy for high-sulfur petroleum coke and applying it to catalytic modification of hydrogen storage performance of magnesium-based materials can open a new pathway for high-quality synergistic conversion of carbon and sulfur in high-sulfur petroleum coke.

### SUMMARY OF THE INVENTION

To overcome the above problems, the present disclosure provides a high-sulfur petroleum coke-based sulfur self-doped mesoporous carbon-supported Fe-TM bimetallic alloy catalyst, and a preparation method and use thereof.

To achieve the above technical objective, the present disclosure adopts the following technical solutions.

In a first aspect, the present disclosure provides a composition for a high-sulfur petroleum coke-based sulfur self-doped mesoporous carbon-supported Fe-TM bimetallic alloy catalyst, comprising:
high-sulfur petroleum coke, potassium ferrate, and a transition metal chloride salt;
wherein a mass ratio of the high-sulfur petroleum coke to the potassium ferrate is 1:(0.5 to 2), and a molar ratio of the transition metal chloride salt to the potassium ferrate is 1:(0.8 to 1.2); and
wherein the high-sulfur petroleum coke has a sulfur content of 3 to 10 wt %.

In the present disclosure, TM is a transition metal.

In a second aspect, the present disclosure provides a high-sulfur petroleum coke-based sulfur self-doped mesoporous carbon-supported Fe-TM bimetallic alloy catalyst, which is formed from the composition of the first aspect by ball milling, calcination under protection of an inert atmosphere, and reduction calcination under a hydrogen atmosphere.

In a third aspect, the present disclosure provides a method for preparing the high-sulfur petroleum coke-based sulfur self-doped mesoporous carbon-supported Fe-TM bimetallic alloy catalyst of the second aspect, comprising the following steps:
(1) ball milling high-sulfur petroleum coke, potassium ferrate, and a transition metal chloride salt to obtain a first intermediate;
(2) heating the first intermediate at a set temperature-rising rate to a set temperature under protection of an inert atmosphere to obtain a second intermediate; and
(3) maintaining the set temperature in step (2), switching the atmosphere to a hydrogen atmosphere to perform reduction calcination, cooling to room temperature after calcination, and washing to obtain the high-sulfur petroleum coke-based sulfur self-doped mesoporous carbon-supported Fe-TM bimetallic alloy catalyst.

In a fourth aspect, the present disclosure provides use of the high-sulfur petroleum coke-based sulfur self-doped mesoporous carbon-supported Fe-TM bimetallic alloy catalyst of the second aspect in catalyzing hydrogen release from MgH₂.

### Advantageous Effects

(1) The present disclosure provides a high-sulfur petroleum coke-based sulfur self-doped mesoporous carbon-supported Fe-TM bimetallic alloy catalyst, and a preparation method and use thereof. The high-sulfur petroleum coke-based sulfur self-doped mesoporous carbon-supported Fe-TM bimetallic alloy catalyst provided by the present disclosure is an Fe-TM solid-solution alloy material supported on sulfur self-doped mesoporous carbon, formed by calcination under an inert atmosphere and reduction calcination under a hydrogen atmosphere after activation of high-sulfur petroleum coke by potassium ferrate.

(2) During calcination under protection of an inert atmosphere, potassium ferrate replaces conventional strong base or strong acid activators and provides dual functions of “activation-modification.” Potassium ferrate forms alkaline activation products at high temperature, introducing more active sites on the surface of the carbon framework formed by carbonization of high-sulfur petroleum coke; meanwhile, it effectively promotes migration of sulfur from the interior of the petroleum coke to the surface of the carbon framework and stably anchors sulfur onto the carbon matrix. Furthermore, potassium ferrate introduces an Fe metal source, thereby modifying the catalyst material with Fe metal. During reduction calcination under a hydrogen atmosphere, Fe and the transition metal (TM) form a solid-solution alloy through solid-state crystal diffusion. Meanwhile, during reduction calcination, the high-sulfur petroleum coke is further carbonized and activated, promoting migration of sulfur from the interior of the petroleum coke to the surface of the carbon framework and uniform self-doping into the carbon framework structure, ultimately forming the Fe-TM solid-solution alloy material supported on sulfur self-doped mesoporous carbon.

(3) Using potassium ferrate as an activator for high-sulfur petroleum coke not only avoids equipment corrosion and excessive washing-water consumption, but also introduces an Fe metal source, reducing the amount of additional metal precursors, optimizing the process flow, lowering production cost, and significantly improving environmental benefits.

(4) In the present disclosure, high-temperature reduction induces solid-state crystal diffusion alloying of Fe-TM bimetals, thereby avoiding catalytic deactivation caused by spontaneous ignition and oxidation of nano-Fe, ensuring catalytic activity of Fe, and further stimulating bimetallic synergistic catalysis to improve catalytic performance.

(5) The high-sulfur petroleum coke-based sulfur self-doped mesoporous carbon-supported Fe-TM bimetallic alloy catalyst provided by the present disclosure can significantly reduce the peak dehydrogenation temperature of magnesium-based materials by 80 to 110 K. The catalytic effect is comparable to catalysts prepared by conventional routes, while its cost effectiveness and environmental advantages are significant, demonstrating the great industrial application potential of high-sulfur petroleum coke in the field of hydrogen storage.

### BRIEF DESCRIPTION OF DRAWINGS

The accompanying drawings, which form a part of this specification, provide a further understanding of the present disclosure. The illustrative embodiments and their descriptions are used to explain the present disclosure and do not constitute an improper limitation thereof.

FIG. 1 is a preparation process of a high-sulfur petroleum coke-based sulfur self-doped mesoporous carbon-supported Fe-TM bimetallic alloy catalyst.

FIG. 2 is an X-ray photoelectron spectroscopy (XPS) spectrum of the high-sulfur petroleum coke-based sulfur self-doped mesoporous carbon-supported Fe-TM bimetallic alloy catalyst FeCu@SC prepared in Example 1 and the material prepared in Comparative Example 1.

FIG. 3 shows nitrogen adsorption/desorption isotherms and pore size distribution plots of the high-sulfur petroleum coke-based sulfur self-doped mesoporous carbon-supported Fe-TM bimetallic alloy catalyst FeCu@SC prepared in Example 1 and the material prepared in Comparative Example 1.

FIG. 4 is an XRD pattern of the high-sulfur petroleum coke-based sulfur self-doped mesoporous carbon-supported Fe-TM bimetallic alloy catalyst FeNi@SC prepared in Example 4.

FIG. 5 is an XRD pattern of a composite material FeOx-Ni@SC prepared in Comparative Example 2.

FIG. 6 is an XRD pattern of a sulfur self-doped mesoporous carbon-supported Fe monometallic catalyst Fe@SC prepared in Comparative Example 3.

FIG. 7 is an XRD pattern of a composite material prepared in Comparative Example 4.

FIG. 8 shows a peak hydrogen-release (dehydrogenation) temperature for catalytic modification of Mg-based hydrogen storage using the high-sulfur petroleum coke-based sulfur self-doped mesoporous carbon-supported Fe-TM bimetallic alloy catalyst FeNi@SC prepared in Example 4.

### DETAILED DESCRIPTION

It should be noted that the following detailed description is exemplary and intended to provide further description of the present disclosure. Unless otherwise specified, all technical and scientific terms used herein have the same meanings as commonly understood by a person of ordinary skill in the technical field to which the present disclosure belongs.

It should be noted that the terms used herein are only for describing specific embodiments, and are not intended to limit the exemplary embodiments of the present disclosure. As used herein, unless the context clearly indicates otherwise, the singular forms are also intended to include plural forms. In addition, it should be understood that when the terms “comprise” and/or “include” are used in this specification, they specify the presence of stated features, steps, operations, devices, components, and/or combinations thereof.

In a first typical embodiment of the present disclosure, a composition for a high-sulfur petroleum coke-based sulfur self-doped mesoporous carbon-supported Fe-TM bimetallic alloy catalyst is provided, comprising:
high-sulfur petroleum coke, potassium ferrate, and a transition metal chloride salt;
wherein a mass ratio of the high-sulfur petroleum coke to the potassium ferrate is 1:(0.5 to 2), and a molar ratio of the transition metal chloride salt to the potassium ferrate is 1:(0.8 to 1.2); and
wherein the high-sulfur petroleum coke has a sulfur content of 3 to 10 wt %.

In one or more embodiments, the metal corresponding to the transition metal chloride salt is selected from chromium, manganese, cobalt, nickel, niobium, or copper.

In a second typical embodiment of the present disclosure, a high-sulfur petroleum coke-based sulfur self-doped mesoporous carbon-supported Fe-TM bimetallic alloy catalyst is provided. The catalyst is formed by ball milling, calcination under protection of an inert atmosphere, and reduction calcination under a hydrogen atmosphere from the composition described above.

In one or more embodiments, calcination under protection of an inert atmosphere comprises heating at a set temperature-rising rate to a set temperature under protection of the inert atmosphere.

Preferably, the set temperature-rising rate is 5 to 10 K/min, and the set temperature is 973 to 1173 K.

In one or more embodiments, reduction calcination under a hydrogen atmosphere comprises maintaining the temperature for calcination under protection of the inert atmosphere, switching the atmosphere to the hydrogen atmosphere, and performing reduction calcination.

Preferably, the reduction calcination temperature is 973 to 1173 K and the reduction calcination time is 2 to 4 h.

The volume fraction of H₂ is 50 to 100%, and the flow rate is 20 to 50 mL/min.

In a third typical embodiment of the present disclosure, a method for preparing the high-sulfur petroleum coke-based sulfur self-doped mesoporous carbon-supported Fe-TM bimetallic alloy catalyst of the second aspect is provided, comprising the following steps:
(1) ball milling high-sulfur petroleum coke, potassium ferrate, and a transition metal chloride salt to obtain a first intermediate;
(2) heating the first intermediate at a set temperature-rising rate to a set temperature under protection of an inert atmosphere to obtain a second intermediate; and
(3) maintaining the set temperature conditions of step (2), switching the atmosphere to a hydrogen atmosphere to perform reduction calcination, cooling to room temperature after calcination, and washing to obtain the high-sulfur petroleum coke-based sulfur self-doped mesoporous carbon-supported Fe-TM bimetallic alloy catalyst.

wherein the potassium ferrate serves as an external chemical activating agent and provides an Fe metal source; and wherein, in the preparation steps, no alkaline chemical activating agent and/or acidic chemical activating agent other than potassium ferrate is additionally introduced as an external chemical activating agent.

In one or more embodiments, in step (1), during ball milling, a ball-to-material ratio is (20 to 50):1, a ball milling speed is 300 to 500 rpm, and a ball milling time is 6 to 10 h.

Ball milling refines powder particle size, shortens diffusion paths, and forms a highly dispersed first intermediate.

In one or more embodiments, in step (2), the inert atmosphere is selected from nitrogen or argon.

In one or more embodiments, in step (2), the set temperature-rising rate is 5 to 10 K/min, and the set temperature is 973 to 1173 K.

In one or more embodiments, in step (3), the reduction calcination temperature under the hydrogen atmosphere is the same as the calcination temperature under protection of the inert atmosphere in step (2), both being 973 to 1173 K, and the reduction calcination time is 2 to 4 h.

The volume fraction of H₂ is 50 to 100%, and the flow rate is 20 to 50 mL/min.

In one or more embodiments, in step (3), the method of washing comprises:
washing with high-purity deionized water until the filtrate after washing has a pH of 7±0.1 and adding a silver nitrate solution to the filtrate produces no precipitate.

In a fourth typical embodiment of the present disclosure, use of the high-sulfur petroleum coke-based sulfur self-doped mesoporous carbon-supported Fe-TM bimetallic alloy catalyst of the second aspect in catalyzing hydrogen release from MgH₂ is provided.

In one or more embodiments, a mass ratio of the high-sulfur petroleum coke-based sulfur self-doped mesoporous carbon-supported Fe-TM bimetallic alloy catalyst to MgH₂ is (5 to 15):(95 to 85).

To enable a person of ordinary skill in the art to more clearly understand the technical solutions of the present disclosure, the technical solutions of the present disclosure are described in detail below with reference to specific examples.

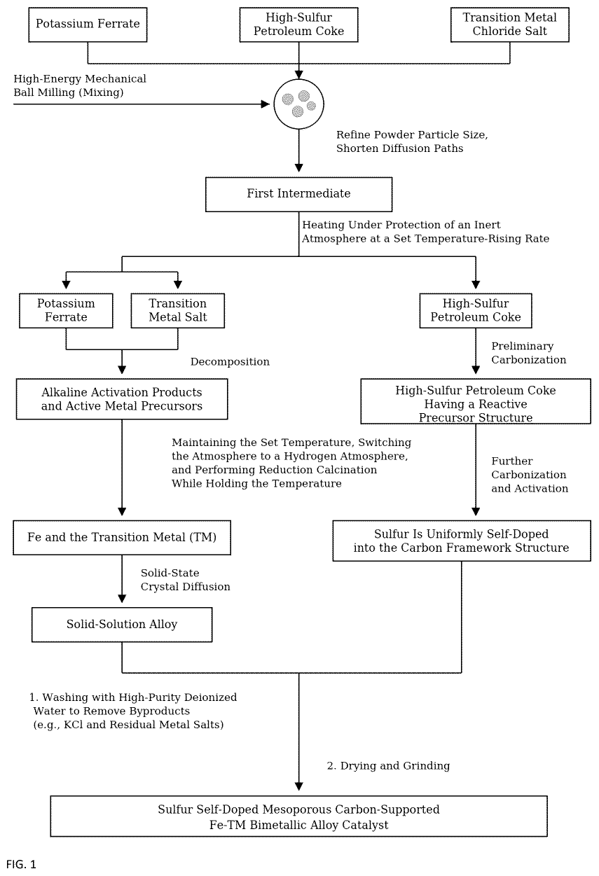

FIG. 1 shows the preparation process of a high-sulfur petroleum coke-based sulfur self-doped mesoporous carbon-supported Fe-TM bimetallic alloy catalyst. Referring to FIG. 1, the high-sulfur petroleum coke-based sulfur self-doped mesoporous carbon-supported Fe-TM bimetallic alloy catalyst is synthesized.

### Example 1

### Preparation of a High-Sulfur Petroleum Coke-Based Sulfur Self-Doped Mesoporous Carbon-Supported Fe-TM Bimetallic Alloy Catalyst:

(1) Synthesis of a first intermediate:

1 g of high-sulfur petroleum coke, 1 g of potassium ferrate, and 0.68 g of copper chloride were weighed and placed into a ball-milling jar. Zirconia balls were added at a ball-to-material ratio of 30:1. High-energy mechanical ball milling was performed using a planetary ball mill for 8 h.

(2) Calcination under protection of an inert atmosphere:
the first intermediate was placed in a metal nickel boat and transferred into a horizontal tube furnace. Under protection of an argon inert atmosphere, the temperature was raised to 1173 K at a heating rate of 5 K/min to obtain a second intermediate.
   (3) Reduction calcination under a hydrogen atmosphere:
the gas source was switched to a hydrogen atmosphere with a flow rate of 30 mL/min and a volume fraction of 100%. Reduction calcination was carried out at 1173 K for 2 h. During reduction calcination, Fe and the transition metal underwent solid-state crystal diffusion to form a solid-solution alloy, while sulfur was uniformly self-doped into the carbon framework.
   (4) Removal of byproducts:

The product obtained in step (3) was washed with high-purity deionized water until the filtrate had a pH of 7 and adding a silver nitrate solution produced no white precipitate. After washing, the product was dried in a forced-air drying oven at 80° C. for 24 h and then ground to obtain the high-sulfur petroleum coke-based sulfur self-doped mesoporous carbon-supported Fe-TM bimetallic alloy catalyst FeCu@SC.

### Comparative Example 1

This comparative example differs from Example 1 in that potassium ferrate was not added in step (1); other conditions were the same as in Example 1.

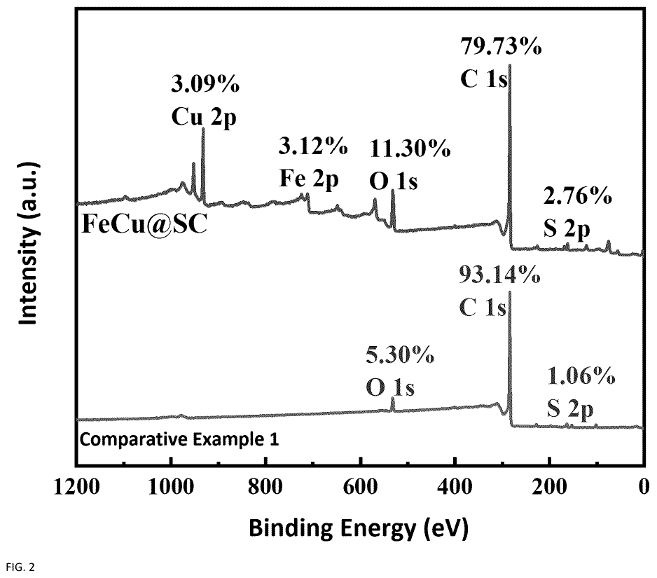

FIG. 2 is an XPS spectrum of the high-sulfur petroleum coke-based sulfur self-doped mesoporous carbon-supported Fe-TM bimetallic alloy catalyst FeCu@SC prepared in Example 1 and the material prepared in Comparative Example 1. As can be seen from FIG. 2, the high-sulfur petroleum coke-based sulfur self-doped mesoporous carbon-supported Fe-TM bimetallic alloy catalyst FeCu@SC prepared in Example 1 clearly confirms the presence of Cu, Fe, O, C, and S elements. The atomic ratio of Cu to Fe is close to 1:1, and the surface S content reaches 2.76 at. %, indicating that sulfur is successfully self-doped in the carbon framework. In contrast, the XPS spectrum of the material prepared in Comparative Example 1 shows that the metal source failed to be effectively loaded and the surface sulfur content is significantly reduced, only 1.06 at. %. As a strong oxidant, potassium ferrate can significantly activate the carbon matrix, introduce more active sites on the surface of the carbon framework, effectively promote migration of sulfur from the interior of petroleum coke to the surface of the carbon framework, and stably fix sulfur on the carbon matrix. Conversely, without potassium ferrate, the carbon matrix lacks sufficient active sites, and its inert structure cannot effectively promote migration and binding of sulfur, further limiting sulfur self-doping.

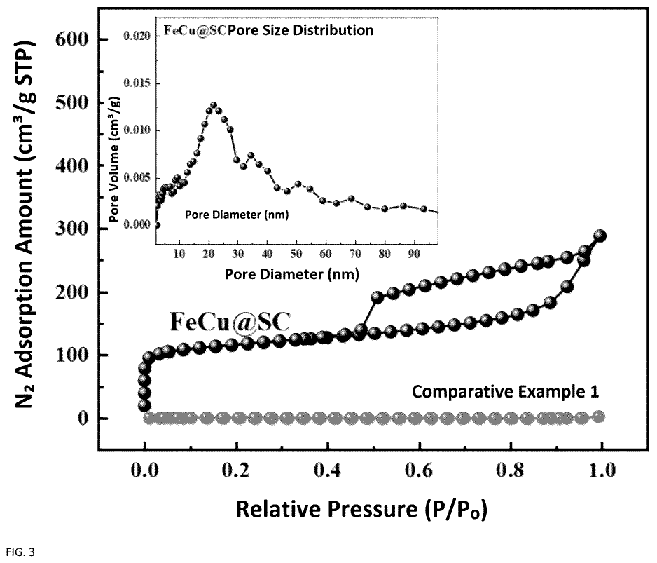

FIG. 3 shows nitrogen adsorption/desorption isotherms and pore size distribution plots of the high-sulfur petroleum coke-based sulfur self-doped mesoporous carbon-supported Fe-TM bimetallic alloy catalyst FeCu@SC prepared in Example 1 and the material prepared in Comparative Example 1. As can be seen from FIG. 3, the high-sulfur petroleum coke-based sulfur self-doped mesoporous carbon-supported Fe-TM bimetallic alloy catalyst FeCu@SC exhibits a Type IV isotherm, has a Brunauer-Emmett-Teller (BET) specific surface area of 370.2 m²/g, and has a Barrett-Joyner-Halenda (BJH) desorption average pore diameter of 4.9 nm, indicating a mesoporous structure. In contrast, in Comparative Example 1 without potassium ferrate, the material still maintains a dense structure and fails to effectively form pores.

### Example 2

This example differs from Example 1 in that 0.68 g of copper chloride in step (1) was replaced with 1.36 g of niobium chloride; other conditions were the same as in Example 1, thereby obtaining the high-sulfur petroleum coke-based sulfur self-doped mesoporous carbon-supported Fe-TM bimetallic alloy catalyst FeNb@SC.

### Example 3

Preparation of a high-sulfur petroleum coke-based sulfur self-doped mesoporous carbon-supported Fe-TM bimetallic alloy catalyst:
(1) synthesis of a first intermediate:

1 g of high-sulfur petroleum coke, 1 g of potassium ferrate, and 0.66 g of cobalt chloride were weighed and placed into a ball-milling jar. Zirconia balls were added at a ball-to-material ratio of 30:1. High-energy mechanical ball milling was performed using a planetary ball mill for 8 h.

(2) Calcination under protection of an inert atmosphere:
the first intermediate was placed in a metal nickel boat and transferred into a horizontal tube furnace. Under protection of an argon inert atmosphere, the temperature was raised to 1073 K at a heating rate of 5 K/min.
   (3) Reduction calcination under a hydrogen atmosphere:
the gas source was switched to a hydrogen atmosphere with a flow rate of 30 mL/min and a volume fraction of 100%. Reduction calcination was carried out at 1073 K for 2 h. During reduction calcination, Fe and the transition metal underwent solid-state crystal diffusion to form a solid-solution alloy, while sulfur was uniformly self-doped into the carbon framework.
   (4) Removal of byproducts:
the product obtained in step (3) was washed with high-purity deionized water until the filtrate had a pH of 7 and adding a silver nitrate solution produced no white precipitate. After washing, the product was dried in a forced-air drying oven at 80° C. for 24 h and then ground to obtain the high-sulfur petroleum coke-based sulfur self-doped mesoporous carbon-supported Fe-TM bimetallic alloy catalyst FeCo@SC.

### Example 4

This example differs from Example 3 in that 0.66 g of cobalt chloride in step (1) was replaced with 0.65 g of nickel chloride; other conditions were the same as in Example 3, thereby obtaining the high-sulfur petroleum coke-based sulfur self-doped mesoporous carbon-supported Fe-TM bimetallic alloy catalyst FeNi@SC.

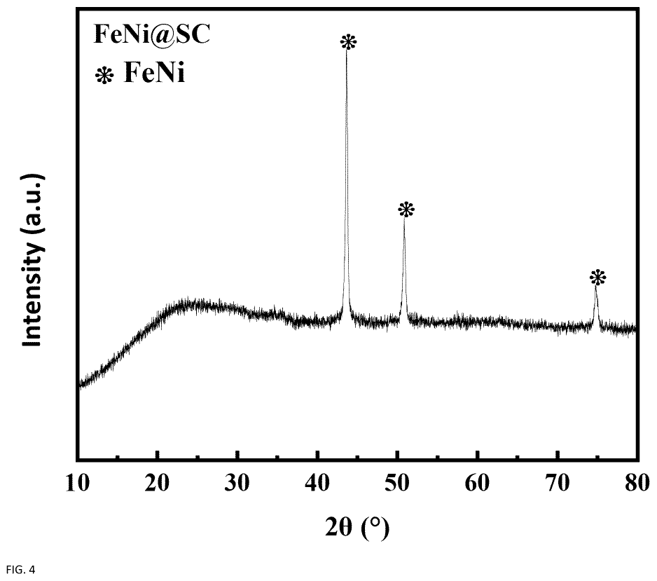

FIG. 4 is an X-ray diffraction (XRD) pattern of the high-sulfur petroleum coke-based sulfur self-doped mesoporous carbon-supported Fe-TM bimetallic alloy catalyst FeNi@SC prepared in Example 4. Strong diffraction peaks corresponding to the FeNi solid-solution alloy are observed at 2θ=43.5°, 50.9°, and 74.9°, corresponding to the (111), (200), and (220) crystal planes, respectively, indicating formation of a highly crystalline alloy structure.

### Comparative Example 2

This comparative example differs from Example 4 in that “1 g of high-sulfur petroleum coke, 1 g of potassium ferrate, and 0.65 g of nickel chloride were weighed and placed into a ball-milling jar” was replaced with “1 g of high-sulfur petroleum coke, 1 g of potassium ferrate, and 0.65 g of nickel chloride were weighed and placed in a mortar”; and “zirconia balls were added at a ball-to-material ratio of 30:1, and high-energy mechanical ball milling was performed using a planetary ball mill for 8 h” was replaced with “thorough grinding in a mortar to uniformly mix the reaction precursors.” Other conditions were the same as in Example 4.

### Comparative Example 3

This comparative example differs from Example 4 in that nickel chloride was not added in step (1); other conditions were the same as in Example 4.

### Comparative Example 4

This comparative example differs from Example 4 in that the reduction calcination under a hydrogen atmosphere in step (3) was replaced by “continuing to maintain an argon atmosphere without switching to a hydrogen atmosphere, with a flow rate of 30 mL/min and a volume fraction of 100%.” Other conditions were the same as in Example 4.

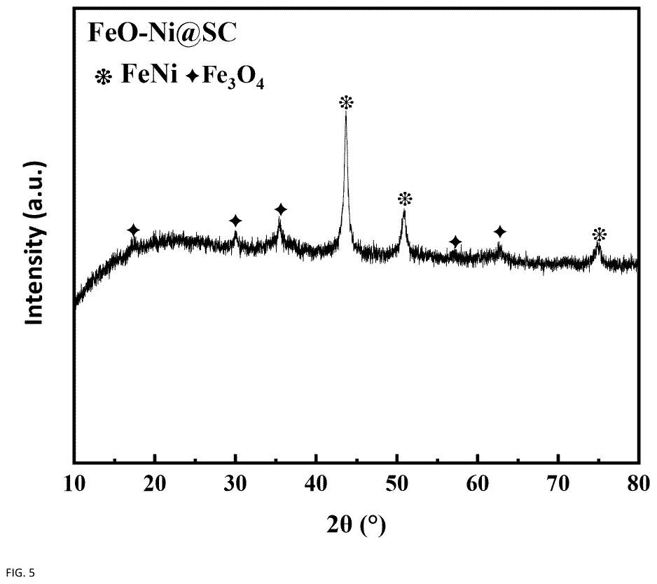

FIG. 5 is an XRD pattern of the composite material FeOx-Ni@SC prepared in Comparative Example 2. As can be seen from FIG. 5, the diffraction peak intensities corresponding to the FeNi alloy at 2θ=43.5°, 50.9°, and 74.9° are significantly lower than those in FIG. 4. Meanwhile, characteristic diffraction peaks corresponding to Fe₃O₄ are detected at 2θ=17.3°, 30.0°, 35.3°, 57.2°, and 62.6°. This indicates that in Comparative Example 2, the precursor mixture had insufficient uniformity due to the lack of high-energy mechanical ball milling, which limited the alloying reaction of Fe and Ni under high-temperature conditions. Fe and Ni failed to completely and fully form a uniform solid-solution alloy, and part of them were oxidized to form an Fe₃O₄ phase, thereby demonstrating that high-energy mechanical ball milling plays an important role in synthesizing bimetallic alloy catalysts.

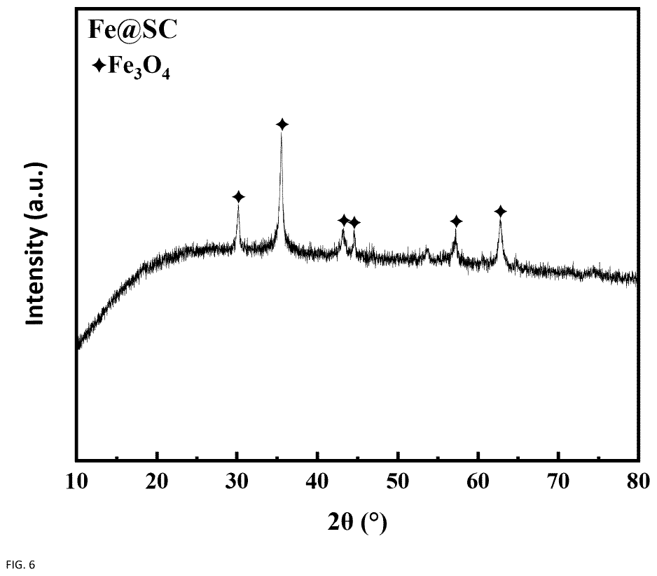

FIG. 6 is an XRD pattern of the sulfur self-doped mesoporous carbon-supported Fe monometallic catalyst Fe@SC prepared in Comparative Example 3. All diffraction peaks in FIG. 6 correspond to Fe₃O₄, and Fe₃O₄ has extremely poor catalytic activity toward MgH₂. This indicates that without participation of a second transition metal, nano-Fe formed from the iron source of potassium ferrate undergoes spontaneous ignition and oxidation in air and becomes deactivated, and cannot exert catalytic activity in subsequent applications.

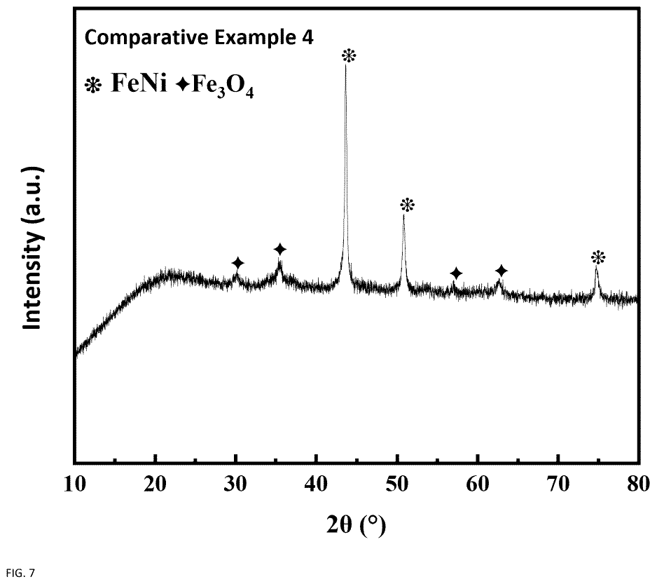

FIG. 7 is an XRD pattern of the composite material prepared in Comparative Example 4. It can be observed from FIG. 7 that in addition to diffraction peaks corresponding to the FeNi solid-solution alloy, a small amount of Fe₃O₄ diffraction peaks also appears. This indicates that hydrogen is a necessary condition for promoting sufficient formation of the bimetallic solid-solution alloy.

The above results show that potassium ferrate plays multiple and critical roles in the preparation method. Its functions include activation and pore expansion, providing an iron source, and achieving controllable sulfur self-doping. Meanwhile, high-energy ball milling, a second transition metal source, and hydrogen are necessary conditions for fully forming the sulfur self-doped mesoporous carbon-supported Fe-TM bimetallic alloy catalyst, and none of them can be omitted.

### Example 5

In this example, the high-sulfur petroleum coke-based sulfur self-doped mesoporous carbon-supported Fe-TM bimetallic alloy catalyst FeNi@SC prepared in Example 4 was used to catalyze MgH₂ to prepare an MgH₂/FeNi@SC composite magnesium-based hydrogen storage material. The specific steps are as follows: 0.2 g of FeNi@SC and 1.8 g of MgH₂ were weighed and placed into a stainless-steel ball-milling jar. 100 g of zirconia milling balls were added at a ball-to-material ratio of 50:1. An argon protective gas was charged into the stainless-steel ball-milling jar. Ball milling was performed in a planetary ball mill by alternating forward and reverse rotation for 6 h. To prevent hydrogen release caused by local overheating, a 10 min interval was provided after every 30 min of ball milling. After ball milling, the milled mixture was collected in a glove box to obtain the MgH₂/FeNi@SC composite magnesium-based hydrogen storage material. A simultaneous thermogravimetric analyzer was used to measure the hydrogen release performance of MgH₂/FeNi@SC. The sample was heated from room temperature to 823 K at a heating rate of 5 K/min, and the peak dehydrogenation temperature was tested.

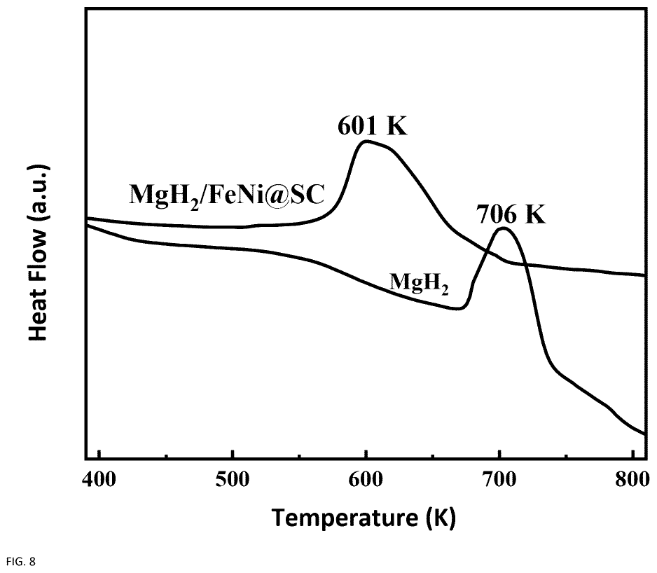

FIG. 8 shows the peak hydrogen-release temperature for catalytic modification of magnesium-based hydrogen storage using the high-sulfur petroleum coke-based sulfur self-doped mesoporous carbon-supported Fe-TM bimetallic alloy catalyst FeNi@SC prepared in Example 4. As can be seen from FIG. 8, compared with pristine MgH₂, the dehydrogenation temperature is reduced by 105 K, demonstrating excellent catalytic performance.

The above results show that the method of the present disclosure can successfully prepare the high-sulfur petroleum coke-based sulfur self-doped mesoporous carbon-supported Fe-TM bimetallic alloy catalyst. High-energy mechanical ball milling and high-temperature reduction treatment ensure sufficient alloying of the Fe-TM bimetal. Benefiting from the Fe-TM bimetallic synergistic catalytic effect and the regulation of electronic properties of the carbon matrix by self-doped sulfur, efficient catalysis of magnesium-based hydrogen storage materials is achieved.

The above description is only of preferred examples of the present disclosure and is not intended to limit the present disclosure. Various modifications and variations can be made by those skilled in the art. Any modifications, equivalent substitutions, improvements, and the like made within the spirit and principle of the present disclosure should fall within the scope of protection of the present disclosure.

1. A high-sulfur petroleum coke-based sulfur self-doped mesoporous carbon-supported Fe-TM bimetallic solid-solution alloy catalyst, comprising:
(a) a sulfur self-doped mesoporous carbon support, wherein sulfur originates from high-sulfur petroleum coke and migrates during a reduction calcination process and is self-doped into a carbon framework structure of the sulfur self-doped mesoporous carbon support; and
(b) an Fe-TM bimetallic solid-solution alloy supported on the sulfur self-doped mesoporous carbon support;
wherein the high-sulfur petroleum coke has a sulfur content of 3 to 10 wt %; and
wherein TM is a transition metal selected from chromium, manganese, cobalt, nickel, niobium, or copper.

2. The catalyst of claim 1, wherein the TM is selected from cobalt, nickel, niobium, or copper.

3. The catalyst of claim 1, wherein the TM is copper.

4. The catalyst of claim 3, wherein X-ray photoelectron spectroscopy (XPS) testing shows an atomic ratio of Cu to Fe close to 1:1, and a surface sulfur content reaching 2.76 at. %.

5. The catalyst of claim 3, wherein the sulfur self-doped mesoporous carbon support has a BET specific surface area of 370.2 m²/g, and a BJH desorption average pore diameter of 4.9 nm.

6. The catalyst of claim 3, wherein the sulfur self-doped mesoporous carbon support exhibits a Type IV isotherm in a nitrogen adsorption/desorption measurement.

7. The catalyst of claim 1, wherein the TM is nickel.

8. The catalyst of claim 7, wherein X-ray diffraction (XRD) testing shows characteristic diffraction peaks of an FeNi solid-solution alloy at 2θ=43.5°, 50.9°, and 74.9°, corresponding to (111), (200), and (220) crystal planes, respectively.

9. The catalyst of claim 1, wherein the catalyst is prepared from a composition comprising high-sulfur petroleum coke, potassium ferrate, and a transition metal chloride salt by ball milling, calcining under an inert atmosphere, and reduction calcining under a hydrogen atmosphere;
wherein a mass ratio of the high-sulfur petroleum coke to the potassium ferrate in the composition is 1:(0.5 to 2), and a molar ratio of the transition metal chloride salt to the potassium ferrate is 1:(0.8 to 1.2);
wherein the potassium ferrate serves as an activator and provides an Fe metal source; and
wherein no additional alkaline chemical activating agent and/or acidic chemical activating agent, other than potassium ferrate, is introduced into the composition as an external chemical activating agent.

10. A method for preparing the catalyst of claim 1, comprising:
(1) mixing and ball milling high-sulfur petroleum coke having a sulfur content of 3 to 10 wt %, potassium ferrate, and a transition metal chloride salt to obtain a first intermediate, wherein a mass ratio of the high-sulfur petroleum coke to the potassium ferrate is 1:(0.5 to 2), and a molar ratio of the transition metal chloride salt to the potassium ferrate is 1:(0.8 to 1.2);
(2) calcining the first intermediate under an inert atmosphere by heating at a temperature-rising rate of 5 to 10 K/min to 973 to 1173 K to obtain a second intermediate;
(3) maintaining the temperature of the second intermediate, switching the inert atmosphere to a hydrogen atmosphere, and performing reduction calcination for 2 to 4 h to induce solid-state crystal diffusion alloying of Fe-TM bimetals to form an Fe-TM bimetallic solid-solution alloy, thereby obtaining a reduced product, wherein the hydrogen atmosphere has a hydrogen volume fraction of 50 to 100%, and a hydrogen flow rate is 20 to 50 mL/min; and
(4) washing and drying the reduced product to obtain the catalyst;
wherein the potassium ferrate serves as an external chemical activating agent and provides an Fe metal source; and wherein no additional alkaline chemical activating agent and/or acidic chemical activating agent, other than potassium ferrate, is introduced as an external chemical activating agent in steps (1)-(3).

11. The method of claim 10, wherein the metal corresponding to the transition metal chloride salt is selected from chromium, manganese, cobalt, nickel, niobium, or copper.

12. The method of claim 10, wherein during the ball milling, a ball-to-material ratio is (20 to 50):1, a ball milling speed is 300 to 500 rpm, and a ball milling time is 6 to 10 h.

13. The method of claim 10, wherein the inert atmosphere is nitrogen or argon.

14. The method of claim 10, wherein the washing comprises washing with deionized water until a filtrate has a pH of 7±0.1 and adding a silver nitrate solution to the filtrate produces no precipitate; and wherein the drying is performed at 80° C. for 24 h.

15. The method of claim 10, wherein the reduction calcination temperature in step (3) under the hydrogen atmosphere is the same as the calcination temperature in step (2) under an inert atmosphere, both being 973 to 1173 K.

16. A method for catalyzing hydrogen release from MgH₂ using the catalyst of claim 1, comprising:
(a) mixing and ball milling the catalyst with MgH₂ to obtain an MgH₂/catalyst composite hydrogen storage material; and
(b) heating the MgH₂/catalyst composite hydrogen storage material to a hydrogen-release temperature to release hydrogen from the MgH₂/catalyst composite hydrogen storage material;
wherein, relative to MgH₂ without the catalyst, a peak dehydrogenation temperature of the MgH₂/catalyst composite hydrogen storage material is lowered by 80 to 110 K.

17. The method of claim 16, wherein the peak dehydrogenation temperature is measured using a simultaneous thermogravimetric analyzer by heating from room temperature to 823 K at a heating rate of 5 K/min.

18. The method of claim 16, wherein a mass ratio of the catalyst to MgH₂ is (5 to 15):(95 to 85), and the ball milling is performed under an inert protective atmosphere, wherein the inert protective atmosphere is argon.

19. The method of claim 16, wherein a ball-to-material ratio of the ball milling is 50:1, a ball milling time is 6 h, and forward and reverse rotation are alternated with a 10 min interval after every 30 min of ball milling.

20. The method of claim 16, wherein the catalyst is FeNi@SC, and the peak dehydrogenation temperature is reduced by 105 K.
